(19) United States
(12) Patent Application Publication
(10) Pub. No.: US 2004/0121781 A1
(43) Pub. Date: Jun. 24, 2004

(54) Wireless terminals that scan for alternate protocol systems responsive to terminal movement and methods of same

(76) Inventor: Anthony J. Sammarco, Garner, NC (US)

Correspondence Address: MYERS BIGEL SIBLEY & SAJOVEC, PO BOX 37428, RALEIGH, NC, 27627, US

(21) Appl. No.: 10/441,582

(22) Filed: May 20, 2003

Related U.S. Application Data
(60) Provisional application No. 60/434,843, filed on Dec. 19, 2002.

(51) Int. Cl. H04Q 7/20

(52) U.S. Cl. 455/456.1; 455/432.1

(57) ABSTRACT

A method for detecting the availability of an alternate wireless communication system. A wireless terminal registers with a first wireless communication system. A determination is made as to whether the wireless terminal has moved out of a selected geographic region. An alternate wireless communication system is scanned for responsive to determining that the wireless terminal has moved out of the selected geographic region. The alternate wireless communication system has a communication protocol that is different from a communication protocol of the first wireless communication system.

### CROSS-REFERENCE TO PROVISIONAL APPLICATION

This application claims the benefit of provisional Application No. 60/434,843, (Attorney Docket No. 9314-29PR), filed Dec. 19, 2002, entitled Method and Apparatus for Reducing Scanning Time, Reducing Missed Pages, and Increasing the Percentages of Successful Call Initiations in Cellular Communication Radiotelephones, the disclosure of which is hereby incorporated herein by reference in its entirety as if set forth fully herein.

### FIELD OF THE INVENTION

This invention relates to cellular wireless terminals that are compliant with more than one cellular communication protocol and operating methods therefor, and more particularly to wireless terminals and operating methods for roaming between wireless communication systems having different communication protocols.

### BACKGROUND OF THE INVENTION

As various wireless communication systems use different communication protocols, it is known to provide wireless terminals that are interoperable among these communication systems. Multi-mode wireless terminals have been developed that can operate on, for example, GSM (Global System for Mobile Communications), ANSI-136 time division multiple access (TDMA) systems, and AMPS (Advanced Mobile Phone Service) systems. In some geographic areas, GSM, ANSI-136, and AMPS systems are all available for use by wireless terminals. To facilitate multi-mode operation among these standards, a GSM ANSI-136 Interoperability Team (GAIT) was established under the Universal Wireless Consortium (UWC) to create a set of standard specifications for multi-mode GSM/TDMA/AMPS wireless terminals. One of the specifications that defines the operation of GAIT wireless terminals is the “GSM/ANSI-136 Common Mobile Terminal Specification Phase 1+, Version 5.1 Aug. 20, 2001”, document GAIT-H-1-1-5-1, which is incorporated by reference herein in its entirety.

Wireless terminals that comply with the GAIT specifications may determine the availability of an alternate communication system while they are registered with a communication system that has a different communication protocol than the alternate communication system. Such wireless terminals may thereby obtain service from either communication system and switch between the systems. For example, while a GAIT compatible wireless terminal is registered with a GSM service provider, and camping on a GSM control channel, it may intermittently perform a background scan to search for an ANSI-136 system. When an ANSI-136 system is found, and is determined to be more favorable than an available GSM system, the wireless terminal may register to receive service from the ANSI-136 system. In this manner, the mobile terminal may identify and switch to a communication system that may provide more revenue to a home service provider with whom the user is registered.

While a wireless terminal is registered with a GSM system, it may temporarily stop camping on (monitoring) a GSM control channel and tune its receiver to search for, and synchronize with, available ANSI-136 control channels. While the wireless terminal is away from the GSM control channel, it may miss any call pages or short message service (SMS) messages, and it may be delayed in initiating a call sequence responsive to a user's dial instruction. Additionally, background scans may shorten the standby time of the wireless terminal. Because wireless terminals might perform background scans as often as every six minutes after the wireless terminal has camped on a GSM control channel, the consequences described above may be significant.

### SUMMARY OF THE INVENTION

Embodiments of the present invention detect the availability of an alternate wireless communication system. A wireless terminal registers with a first wireless communication system. A determination is made as to whether the wireless terminal has moved out of a selected geographic region. The wireless terminal scans for the alternate wireless communication system responsive to a determination that the wireless terminal has moved out of the selected geographic region. The alternate wireless communication system uses a communication protocol that is different from a communication protocol of the first wireless communication system.

Accordingly, the wireless terminal may determine the availability of an alternate communication system, and may thereby obtain service on a more preferable communication system. Because the wireless terminal initiates the scan responsive to a determination that it has moved out of the selected geographic region, it may be more likely to find an alternate wireless communication system than with one or more scans performed within the geographic areas. Accordingly, the number of unsuccessful scans may be reduced.

According to other embodiments of the present invention, the determination of whether the wireless terminal has moved out of the selected geographic region is based on identification information received from the first wireless communication system. The identification information may include a location area code, a routing area identifier, a base station identity code, a cell identity value, a digital verification color code, and/or a virtual mobile location area code. According to other embodiments of the present invention, the determination of whether the wireless terminal has moved out of the selected geographic region may be responsive to a cell reselection (e.g., handover).

### BRIEF DESCRIPTION OF THE DRAWINGS

FIG. 1 illustrates a multi-mode wireless terminal and two wireless communication systems according to embodiments of the present invention.

FIG. 2 illustrates the two wireless communication systems of FIG. 1 configured to provide communication services within geographic regions, including some overlapped geographic regions, and a multi-mode wireless terminal that has moved from one geographic region to another.

FIG. 3 illustrates geographic regions serviced by one of the wireless communication systems of FIG. 2.

FIGS. 4 and 5 illustrate operations for detecting the availability of an alternate wireless communication system according to other embodiments of the present invention.

### DETAILED DESCRIPTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

It also will be understood that, as used herein, the term “comprising” or “comprises” is open-ended, and includes one or more stated elements, steps and/or functions without precluding one or more unstated elements, steps and/or functions.

The present invention is described below with reference to block diagrams and/or operational illustrations of methods and wireless terminals according to embodiments of the invention. It is understood that each block of the block diagrams and/or operational illustrations, and combinations of blocks in the block diagrams and/or operational illustrations, can be implemented by radio frequency, analog and/or digital hardware, and/or computer program instructions. These computer program instructions may be provided to a processor of a general purpose computer, special purpose computer, ASIC, and/or other programmable data processing apparatus in a wireless terminal, Such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

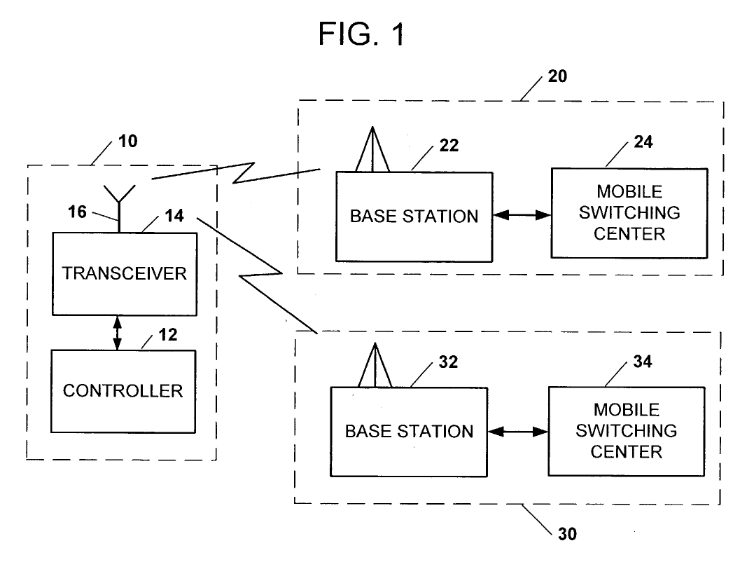

FIG. 1 illustrates a multi-mode wireless terminal 10 that is configured to communicate with at least two types of wireless communication systems 20 and 30. The wireless communication systems 20 and 30 use different wireless communication protocols. As illustrated in FIG. 1, the wireless communication systems 20 and 30 each include a base station 22 and 32, respectively, and a mobile switching center 24 and 34, respectively. Although only two bases stations 22 and 32 are shown, a typical cellular system may include hundreds of base stations, many mobile switching centers, and may serve thousands of wireless terminals. The base station 22 may communicate with the wireless terminal 10 using a GSM communication protocol, and the base station 32 may communicate with the wireless terminal 10 using an ANSI-136 communication protocol. The mobile switching centers 24 and 34 may connect the base stations 22 and 32, respectively, with a landline communication system, such as a public switched telephone network (PSTN).

For the embodiments of the present invention illustrated in FIG. 1, the multi-mode wireless terminal 10 includes a controller 12, a transceiver 14, and an antenna 16. The controller 12 is configured to communicate according to at least two different 10 communication protocols. For example, the controller 12 may be configured to communicate according to the GSM and ANSI-136 communication protocols through the transceiver 14. The transceiver 14 is configured to transmit and receive information signals via the antenna 16 with one of the wireless communication systems 20 and 30 at a time.

As used herein, a “wireless terminal” includes, but is not limited to, a cellular wireless terminal; a personal communication terminal that may combine a cellular wireless terminal with data processing, facsimile and data communications capabilities; a personal data assistance (PDA) that can include a wireless transceiver, pager, Internet/intranet access, local area network interface, wide area network interface, Web browser, organizer, and/or calendar; and a mobile or fixed computer or other device that includes a wireless transceiver. The wireless terminal 10 may be configured to communicate according to two or more wireless communication protocols, including, but not limited to, ANSI-136, GSM, code division multiple access (CDMA), wideband-CDMA, CDMA2000, EDGE, UMTS, a wireless local area network (WLAN) protocol, including IEEE 802.11b, and Bluetooth, satellite protocols, private land mobile radio protocols, including PROJECT-25 and Tetra, and/or other communication protocols. Communication protocols as used herein may specify the information communicated, the timing, the frequency, the modulation, and/or the operations for setting-up and/or maintaining a communication connection.

Thus, it will be understood that embodiments of the present invention are not to be construed as limited to any one particular type of wireless terminal or communication protocol, and are not limited only to dual mode operation wireless terminals, as tri-mode and higher-mode wireless terminals are included in some embodiments of the present invention.

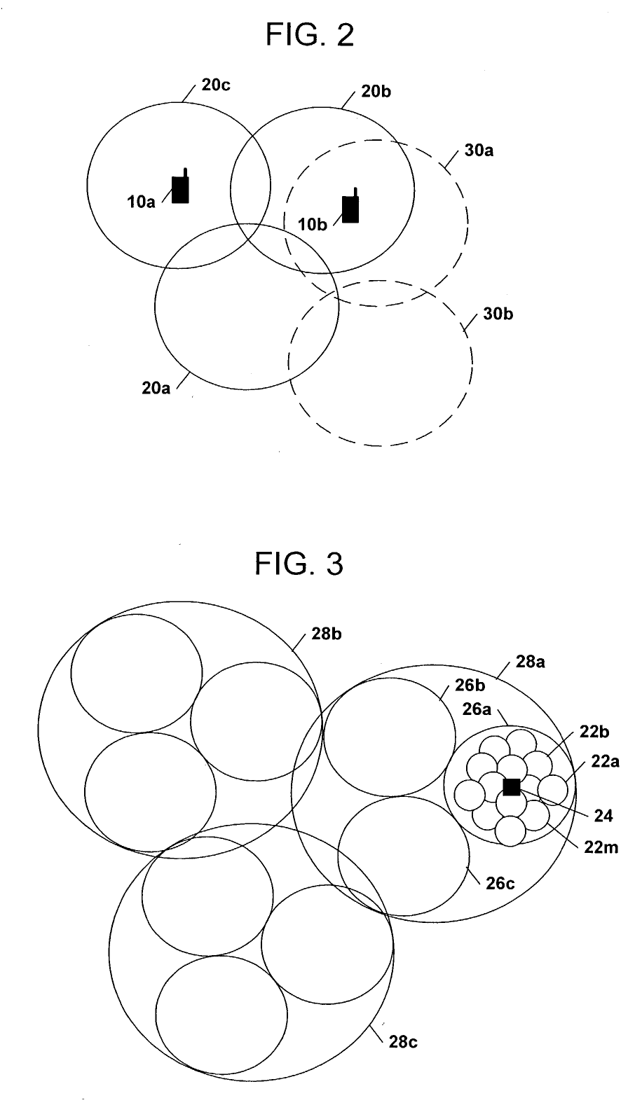

With reference to FIG. 2, the wireless communication systems 20 and 30 are configured to provide communication services within geographic regions 20a-c and 30a-b, respectively, including some overlapping geographic regions. The wireless terminal 10 is configured to communicate with the wireless communication system 20 using a first communication protocol and to communication with the wireless communication system 30 using a second communication protocol that is different from the first communication protocol.

To facilitate the understanding of the present invention, the wireless communication system 30 will be considered a preferred or primary system, and assumed to be an ANSI-136 system, and the wireless communication system 20 will be considered a non-preferred or secondary system, and assumed to be a GSM system. For example, upon power-up, the wireless terminal 10 may first scan for the presence of the preferred communication system 30. As used herein, the term “scan” includes any operations for detecting the presence of a wireless communication system, including by searching within a frequency range for one or more control channels or traffic channels, and/or searching for one or more patterns or code sequences. If the wireless terminal 10 is unable to register with the preferred system, it may then locate and register with the non-preferred wireless communication system 20, depending upon its availability. For example, with reference to FIG. 2, when the wireless terminal 10 is located within the geographic region 20c of the first wireless communication system 20 it may register and use the services of the first wireless communication system 20, but not the services of the wireless communication system 30 which is not available. Wireless communication system 30 may not be available because, for example, it does not provide coverage within the geographic region 20c, or for other reasons such as its utilization with other wireless terminals or its received signal quality.

While the wireless terminal 10 is registered to receive services from wireless communication system 20, according to the GSM communication protocol, it may be moved from the geographic region 20c, shown by location 10a, to the region 20b, shown by location 10b, that has overlapping coverage with region 30a that is serviced by the wireless communication system 30. According to some embodiments of the present invention, the wireless terminal 10 is configured to determine when it has moved out of a selected geographic region, and to detect the availability of an alternate wireless communication system responsive to a determination that it has moved out of the selected geographic region.

According to some embodiments of the present invention, the wireless terminal 10 determines whether it has moved based on identification information received from the wireless communication system with which it is registered. Continuing with the example embodiment, the wireless terminal 10 determines from identification information that it receives from communication system 20 that it has moved out of the selected geographic region 20c. Responsive to this determination, the wireless terminal 10 scans for an alternate wireless communication system. During scanning the wireless terminal 10 may remain registered with the wireless communication system 20 while scanning for an alternate wireless communication system (referred to as a) “background scan”). The wireless terminal 10 scans, for example, using an ANSI-136 intelligent roaming protocol, for services that are provided by an ANSI-136 communication system. With the wireless terminal 10 located at position 10b, in region 20b/30a, it may detect the availability of the wireless communication system 30. Because wireless communication system 30 is a preferred system, for this example, the wireless terminal 10 may register with wireless communication system 30 and stop using the services of wireless communication system 20.

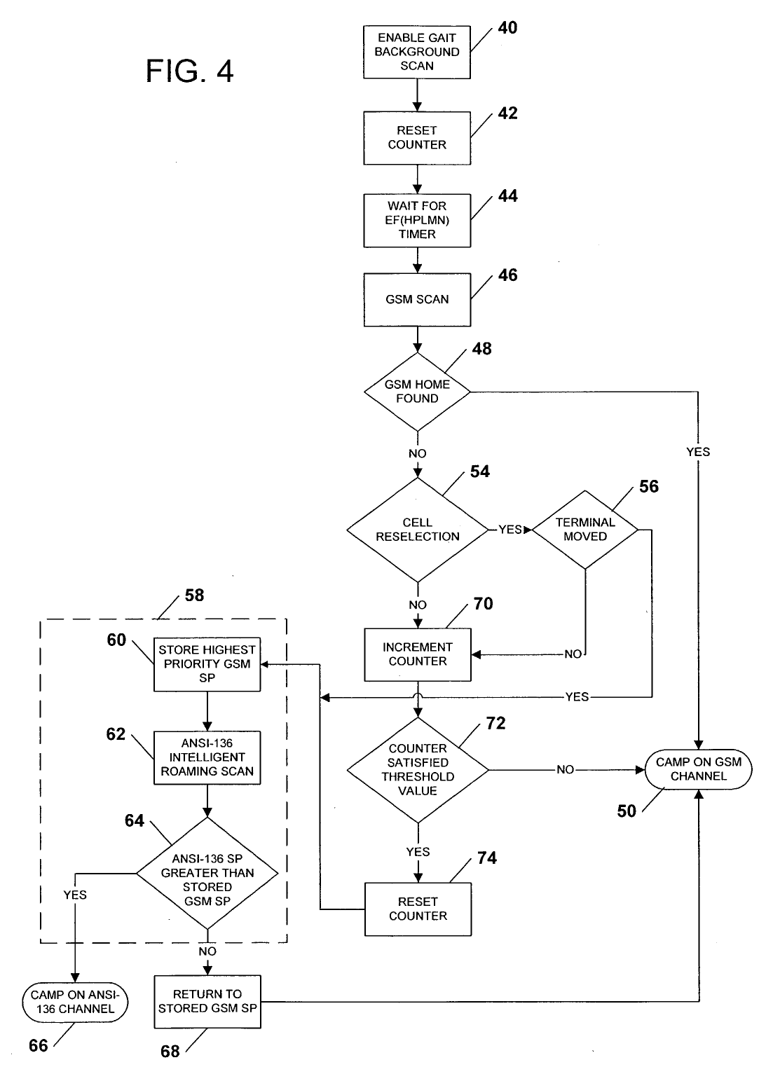

Referring to FIG. 3, the wireless communication system 20 may assign an identity code, or cell code, to each of the cell regions 22a-m that are serviced by a base station 24 having directional antennas. The identity codes may be transmitted by the base station within the corresponding cell regions 22a-m. The wireless terminal 10 may determine whether it has moved based upon a change in received identity code. The identity codes may be unique for each of the cell regions 22a-m, or they may be common for all of the cells regions 22a-m that are serviced by the base station 24. A change in received identity code may, therefore, correspond to movement of the wireless terminal 10 between cell regions that are serviced by the same base station (when the cell regions for a base station have unique identity codes), or it may correspond to movement between base station service regions (when the cell regions for a base station have a common identity code). Other base stations may be used in the wireless communication system 20 that use a non-directional antenna, and which may service only one cell region.

With further reference to FIG. 3, the wireless communication system 20 may assign unique routing area identifiers to groups of cells that route, for example, packet switched data to the same geographic region. Three packet routing geographic regions are shown as 26a-c in FIG. 3. The wireless communication system 20 may transmit the unique routing area identifier to wireless terminals that are within the corresponding geographic regions 26a-c. The wireless terminal 10 may determine whether it has moved out of a selected geographic region based upon a change in the received routing area identifier.

With further reference to FIG. 3, the wireless communication system 20 may assign a unique location area identifier to still larger selected geographic regions 28a-c. The selected geographic regions 28a-c include a plurality of cell regions, and may further include a plurality of packet routing geographic regions. The unique location area identifier may be transmitted to wireless terminals that are within the corresponding geographic regions 28a-c. The wireless terminal 10 may determine whether it has moved based upon a change in the received location area identifier.

According to further embodiments of the present invention, the wireless terminal 10 determines that it has moved when it performs a cell reselection (i.e., handoff may be used as an indication of movement out of a selected geographic region). However, handoff may occur without movement of the wireless terminal 10, due to, for example, the quality of the service or to balance the user loading of systems. According to other embodiments of the present invention, the wireless communication system 20 may communicates according to the ANSI-136 protocol, instead of the GSM protocol as described above with regard to some embodiments, and the wireless terminal 10 determines whether it has moved based upon a change in the received digital verification color code and/or a change in the received virtual mobile location code, where the digital verification color code and the virtual mobile location code are defined by the ANSI-136 protocol.

In other embodiments of the present invention, the wireless terminal 10 may attempt to detect the availability of alternate wireless communication systems responsive to expiration of a time duration, such as while it is camping on a control channel, or responsive to a command received from a user, or a wireless communication system, and/or a combination thereof.

Accordingly, the wireless terminal 10 may determine the availability of an alternate wireless communication system, and may thereby obtain service from, for example, a more preferable available wireless communication system. While the wireless terminal 10 is scanning for an alternate wireless communication system, it may stop camping on (monitoring) the control channel of the wireless communication system with which it is registered. Consequently, the wireless terminal 10 may be temporarily unavailable to that wireless communication system. For example, a page or SMS message could be missed and, therefore, have to be retransmitted. However, because the wireless terminal 10 initiates the scan responsive to a determination that it has moved out of a selected geographic region, it may be possible to initiate scans less frequently and under conditions where the wireless terminal 10 may be more likely to find an alternate wireless communication system because the wireless terminal 10 has moved. Accordingly, the number of scans, and the time during which the wireless terminal 10 may be unavailable, may be reduced according to various embodiments of the present invention.

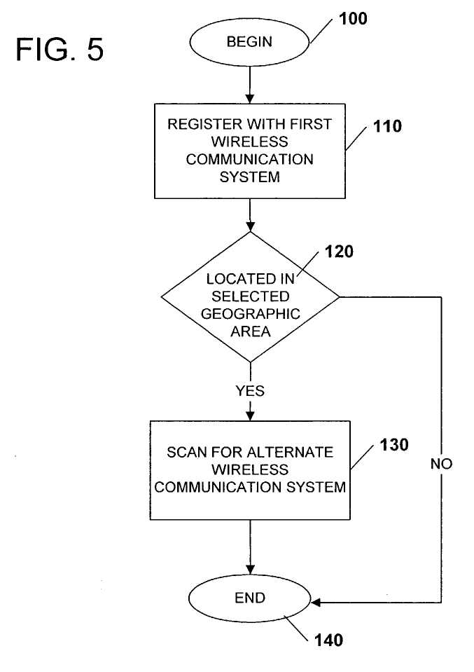

FIG. 4 illustrates operations for detecting the availability of an alternate wireless communication system according to some embodiments of the present invention. At Block 40, a wireless terminal that is registered with a first wireless communication system is enabled to perform a background scan for an alternate wireless communication system using a different communication protocol than it uses to communicate with the first wireless communication system. For purposes of illustration only, it is assumed that the wireless terminal is initially registered with a GSM system and that the alternate wireless communication system is an ANSI-136 system.

At Block 42 a counter is reset and the wireless terminal waits at Block 44 for the expiration of a timer, EFhplimn, which corresponds to the time that the wireless terminal has camped on a control channel since its last scan for a higher priority (more favorable) system. After expiration of the timer, a scan is made at Block 46 to identify another GSM system that has a higher priority than the first wireless communication system with which the wireless terminal is registered. The scan at Block 46 is performed using the same communication protocol, GSM, as the first wireless communication system. The scan for an alternate GSM system is performed while the wireless terminal remains camped on a GSM control channel from the first wireless communication system.

At Block 48, when the scan detects a home (more favorable) GSM wireless communication system, the wireless terminal registers with the home GSM wireless communication system and, at Block 50, camps on a communication control channel of the home wireless communication system. Otherwise, a determination is made at Block 54 as to whether the wireless terminal has performed a cell reselection since the last expiration of the timer EFhplmn. When a cell reselection has occurred, a determination is made at Block 56 as to whether the wireless terminal has moved out of a selected geographic region. According to some embodiments of the present invention, the determination of whether the wireless terminal has moved out of the selected geographic region is based on identification information received from the first wireless communication system. According to further embodiments of the present invention, the identification information includes a location area code, a routing area identifier, a base station identity code, and/or a cell identity value.

When the wireless terminal has moved (Block 56), a background scan is performed for an ANSI-136 system (an alternate wireless communication system), at Block 58, using the ANSI-136 communication protocol. According to some embodiments of the present invention, the background scan at Block 58 may include storing the highest priority known provider of services (also referred to as “service provider” or “SP”) on a GSM wireless communication system at Block 60. An ANSI-136 intelligent roaming scan is performed at Block 62 to identify available ANSI-136 wireless communication systems. At Block 64, a decision is made as to whether any identified ANSI-136 wireless communication systems are serviced by a higher priority service provider than that stored at Block 60. If so (Block 64), at Block 66, the wireless terminal registers with a higher priority ANSI-136 service provider communication system and camps on one of its communication control channels for services. At Block 68, if no higher priority ANSI-136 communication system was identified (Block 64), the wireless terminal registers with the GSM communication system that corresponds to the service provider stored at Block 60, and then camps on that systems' control channel at Block 50.

When a decision is made at Block 54 that a cell reselection has not occurred since the last expiration of the timer EFhplmn, or when a decision is made at Block 56 that the wireless terminal has not moved out of the selected geographic region, the counter is incremented at Block 70. A determination is then made at Block 72 as to whether the counter satisfies a configurable threshold value. According to some embodiments of the present invention, the threshold value may configured, for example by a service provider, to correspond to a maximum time that the wireless terminal is allowed to camp on a control channel before scanning for an alternate wireless communication system. When the counter satisfies the threshold value (Block 72), the counter is reset at Block 74, and a background scan for an alternative wireless communication system is made at Block 58. When the counter does not satisfy the threshold value (Block 72), at Block 50 the wireless terminal camps on a control channel from the wirelesse communication system that corresponds to the highest priority service provider that was identified during the scan of Block 46.

FIG. 5 illustrates operations for detecting the availability of an alternate wireless communication system according to other embodiments of the present invention. After beginning at Block 100, a wireless terminal registers at Block 110 with a first wireless communication system that has a first communication protocol. The wireless terminal determines at Block 120 whether it has moved out of a selected geographic region. When the wireless terminal has moved out of a selected geographic region, the wireless terminal scans at Block 130 for an alternate wireless communication system that has a second communication protocol that is different from the first communication protocol. When the wireless terminal is determined to have not moved out of the selected geographic region, at Block 120, the operations may end at Block 140. According to some further embodiments of the present invention, the determination of whether the wireless terminal has moved out of a selected geographic region may be based on identification information that the wireless terminal receives from the first wireless communication system.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A method for detecting availability of an alternate wireless communication system, the method comprising:
registering with a first wireless communication system having a first communication protocol from a wireless terminal;
determining if the wireless terminal has moved out of a selected geographic region; and
scanning for the alternate wireless communication system responsive to determining that the wireless terminal has moved out of the selected geographic region, the alternate wireless communication system having a second communication protocol that is different from the first communication protocol.

2. The method of claim 1 wherein scanning for the alternate wireless communication system responsive to determining that the wireless terminal has moved out of the selected geographic region comprises scanning for the alternate wireless communication system only if the wireless terminal has moved out of the selected geographic region.

3. The method of claim 1 wherein determining if the wireless terminal has moved out of a selected geographic region comprises determining if the wireless terminal has moved based on identification information received from the first wireless communication system.

4. The method of claim 3 wherein the first wireless communication system provides a different location area code to groups of communication cells in corresponding different geographic regions, and wherein determining if the wireless terminal has moved out of a selected geographic region comprises determining whether the wireless terminal has received a different location area code from the first wireless communication system.

5. The method of claim 3 wherein the first wireless communication system provides a different routing area identifier to groups of cells that route packet switched data to corresponding different geographic regions, and wherein determining if the wireless terminal has moved out of a selected geographic region comprises determining whether the wireless terminal has received a different routing area identifier from the first wireless communication system.

6. The method of claim 3 wherein:
registering with a first wireless communication system comprises registering with an ANSI-136 system; and
determining if the wireless terminal has moved out of a selected geographic region comprises determining whether a digital verification color code received from the ANSI-136 system has changed.

7. The method of claim 3 wherein:
registering with a first wireless communication system comprises registering with an ANSI-136 system; and
determining if the wireless terminal has moved out of a selected geographic region comprises determining if the wireless terminal has moved based on a virtual mobile location area code received from the ANSI-136 system.

8. The method of claim 1 wherein:
registering with a first wireless communication system from a wireless terminal comprises registering with a GSM system; and
scanning for the alternate wireless communication system responsive to determining that the wireless terminal has moved out of the selected geographic region comprises scanning using an ANSI-136 intelligent roaming protocol.

9. The method of claim 1 wherein determining if the wireless terminal has moved out of a selected geographic region comprises determining whether the wireless terminal has performed a cell reselection.

10. A method according to claim 1, further comprising scanning for the presence of a further wireless communication system having the same communication protocol as the first wireless communication system, after registering with a first wireless communication system from a wireless terminal, and before scanning for the alternate wireless communication system.

11. A method according to claim 10, further comprising registering with the further wireless communication system identified by scanning for the presence of a further wireless communication system having the same communication protocol as the first wireless communication system.

12. A method according to claim 1, wherein scanning for the alternate wireless communication system is responsive to an expiration of a time value related to how long the wireless terminal has camped on a control channel that is associated with the first wireless communication system.

13. A wireless terminal comprising:
a controller that is configured to register with a first wireless communication system, and to determine if the wireless terminal has moved out of a selected geographic region, and to scan for an alternate wireless communication system having a communication protocol that is different from the first wireless communication system, wherein the scan is responsive to a determination that the wireless terminal has moved out of the geographic region.

14. The wireless terminal of claim 13 wherein the controller is further configured to scan for the alternate wireless communication system only if the wireless terminal has moved out of the selected geographic region.

15. The wireless terminal of claim 13 wherein the controller is further configured to determine if the wireless terminal has moved based on identification information received from the first wireless communication system.

16. The wireless terminal of claim 13 wherein the controller is further configured to determine if the wireless terminal has moved based on a location area code received from the first wireless communication system.

17. The wireless terminal of claim 13 wherein the controller is further configured to determine if the wireless terminal has moved based on a routing area identifier received from the first wireless communication system.

18. The wireless terminal of claim 13 wherein the controller is further configured to register with an ANSI-136 system, and to determine if the wireless terminal has moved based on a digital verification color code received from the ANSI-136 system.

19. The wireless terminal of claim 13 wherein the controller is further configured to register with an ANSI-136 system, and to determine if the wireless terminal has moved based on a virtual mobile location area code received from the ANSI-136 system.

20. The wireless terminal of claim 13 wherein the controller is further configured to register with a GSM system, and to scan for an ANSI-136 system using an ANSI-136 intelligent roaming protocol.

21. The wireless terminal of claim 13 wherein the controller is further configured to determine if the wireless terminal has moved based on whether the wireless terminal has performed a cell reselection.

22. The wireless terminal of claim 13 further comprising a transceiver that is configured to communicate information signals with the first wireless communication system and the alternate wireless communication system.

23. The wireless terminal of claim 13 wherein the controller is further configured to scan for the alternate wireless communication system in response to an expiration of a time value related to how long the wireless terminal has camped oil a control channel that is associated with the first wireless communication system.

24. A wireless terminal comprising:
controller means for registering with a first wireless communication system, for determining if the wireless terminal has moved out of a selected geographic region, and for scanning for an alternate wireless communication system having a communication protocol that is different from the first wireless communication system, wherein the scanning is responsive to a determination that the wireless terminal has moved out of the geographic region.
